(19) United States
(12) Patent Application Publication
(10) Pub. No.: US 2024/0251325 A1
(43) Pub. Date: Jul. 25, 2024

(54) CONTROL APPARATUS, COMMUNICATION SYSTEM, CONTROL METHOD AND PROGRAM

(71) Applicant: NIPPON TELEGRAPH AND TELEPHONE CORPORATION, Tokyo (JP)

(72) Inventors: Daisuke MURAYAMA, Tokyo (JP); Shota NAKAYAMA, Tokyo (JP)

(21) Appl. No.: 18/560,795

(22) PCT Filed: Jun. 23, 2021
(86) PCT No.: PCT/JP2021/023869

§ 371 Date: Nov. 14, 2023

(51) Int. Cl. H04W 40/20; H04W 16/18; H04W 16/24; H04W 40/02

(52) U.S. Cl. CPC H04W 40/205; H04W 16/18; H04W 16/24; H04W 40/026

(57) ABSTRACT

A control apparatus in a communication system including the control apparatus and a mobile base station includes an information acquisition unit that acquires positional information of a specific priority terminal and obstruction sensing information, an obstruction map generation unit that generates an obstruction map based on the obstruction sensing information, a line-of-sight determination unit that determines whether there is a line-of-sight from an antenna of the mobile base station for the specific priority terminal based on the positional information and the obstruction map, and a base station control unit that controls the mobile base station so that the specific priority terminal is positioned at a line-of-sight position from the antenna in a case where communication by the specific priority terminal is not detected for a predetermined time.

### TECHNICAL FIELD

The present invention relates to a method of controlling a base station in a wireless communication system.

### BACKGROUND ART

The introduction of 5G, which realizes large-capacity systems, high-speed data transmission speeds, low latency, simultaneous connection of many terminals or the like is underway. In 5G, in addition to the frequency bands currently used in movable communications, high frequency bands such as millimeter wave bands are used (Non Patent Literature 1).

### CITATION LIST

### Non Patent Literature

NPL 1: 5G Outdoor Experiment For Ultra-High Speed And Long Distance Transmission Using Millimeter Waves, Kishiyama, Okumura, et al., NTT DOCOMO Technical Journal (Vol. 26-1, P25-32)

### SUMMARY OF INVENTION

### Technical Problem

There is a use case in which a monitoring camera terminal (an example of a specific priority terminal) periodically uploads large-capacity data by utilizing a high-frequency band in a factory. However, there are many obstructions, and communication quality is not stable in a factory where the obstructions move. The radio wave of a high frequency band such as 5G has high rectilinearity and large loss due to obstruction.

The present invention has been made in view of the above points, and an object of the present invention is to provide a technique that enables regular communication of a specific priority terminal to be maintained even in an environment where an obstruction exists.

### Solution to Problem

According to the disclosed technique, there is provided a control apparatus in a communication system including the control apparatus and a mobile base station, the control apparatus including
an information acquisition unit that acquires positional information of a specific priority terminal and obstruction sensing information,
an obstruction map generation unit that generates an obstruction map based on the obstruction sensing information,
a line-of-sight determination unit that determines whether there is a line-of-sight from an antenna of the mobile base station for the specific priority terminal based on the positional information and the obstruction map, and
a base station control unit that controls the mobile base station so that the specific priority terminal is positioned at a line-of-sight position from the antenna in a case where communication by the specific priority terminal is not detected for a predetermined time.

### Advantageous Effects of Invention

According to the disclosed technique, regular communication of the specific priority terminal can be maintained even in an environment in which an obstruction exists.

### BRIEF DESCRIPTION OF DRAWINGS

FIG. 1 is a diagram illustrating a configuration example of a communication system in an embodiment of the present invention.

FIG. 2 is a diagram illustrating a mobile base station 100.

FIG. 3 is a diagram illustrating a configuration of each device in a communication system.

FIG. 4 is a flowchart illustrating an operation of the communication system.

FIG. 5 is a diagram illustrating a control example of a mobile base station.

FIG. 6 is a diagram illustrating a hardware configuration example of an apparatus.

### DESCRIPTION OF EMBODIMENTS

Hereinafter, an embodiment (present embodiment) of the present invention will be described with reference to the accompanying drawings. The embodiment described below is a mere example, and embodiments in which the present invention is implemented are not limited to the following embodiment.

### Overview of Embodiment

In this embodiment, a technique for maintaining the regular communication of a specific priority terminal in a factory or the like having many obstructions is described mainly for a communication system such as 5G and for a use case requiring the periodic communication of low frequency and high reliability of the specific priority terminal.

The specific priority terminal is, for example, a monitoring camera terminal capable of storing video data for about one hour. When the specific priority terminal is a monitoring camera terminal, in the use case, the monitoring camera terminal needs to periodically, for example, about once per hour, upload a large amount of data in the area of the high frequency band. However, in a factory with many obstructions and moving obstructions, communication is interrupted. Therefore, it difficult to perform regular uploading as described above. Therefore, in the present embodiment, the regular communication is maintained by controlling the position and direction of the antenna of the mobile base station.

A control device 300 (control apparatus), which will be described later, executes the control for maintaining the regular communication of the specific priority terminal. The outline of control is as follows.

The control device 300 calculates parameters indicating a position/a direction of an antenna of a mobile base station by which the specific priority terminal arrives at a line-of-sight position based on the obstruction sensing information (camera video information, LiDAR information, or the like) and the positional information of the specific priority terminal, the calculated information being held in a storage unit.

When the control device 300 determines that the specific priority terminal has no history of communication for a fixed time (or each time a fixed time elapses) based on the communication history of the specific priority terminal, the control device 300 controls the mobile base station according to the position/the direction parameters of the antenna of the mobile base station where the specific priority terminal is in line-of-sight position.

By such control, even in an environment where there is an obstruction and the obstruction moves, regular communication of the specific priority terminal can be maintained, and communication reliability can be improved.

Hereinafter, the present embodiments will be described in more detail.

### System Configuration Example

In the present embodiment, it is assumed that the communication area of the wireless communication system is formed in an environment such as a factory or warehouse where a large obstruction moves semi-statically or dynamically. The communication area is covered by a single or a plurality of base stations.

The present invention can be applied to any wireless communication system. However, in the present embodiment, it is assumed that the radio communication system is mainly 5G or the like, and particularly the radio communication system using a frequency with high rectilinearity such as Above-6 GHZ is used.

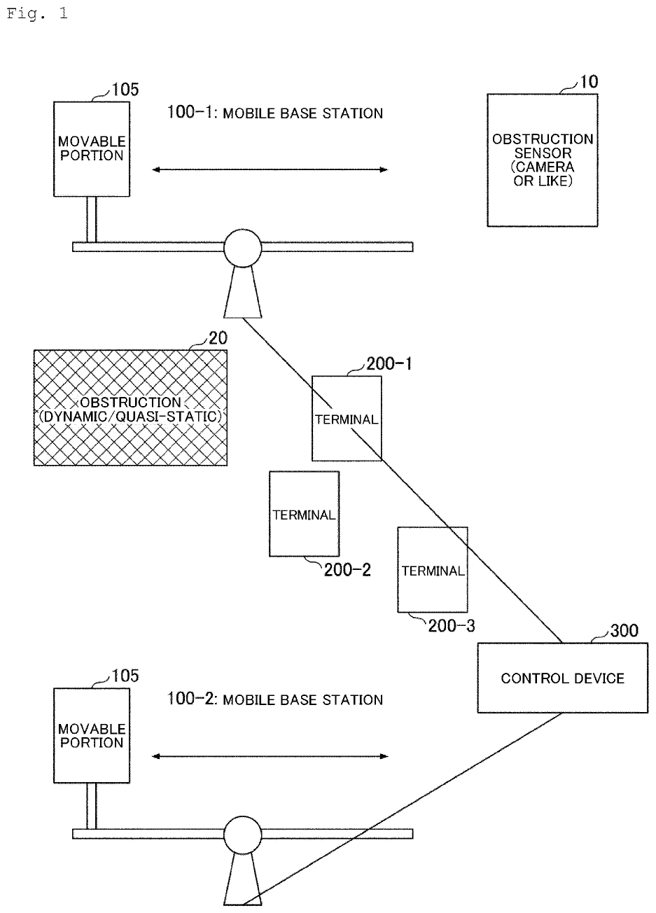

FIG. 1 illustrates an overall configuration example of a communication system according to the present embodiment. As illustrated in FIG. 1, the present communication system includes a mobile base station 100-1, a mobile base station 100-2, an obstruction sensor 10, an obstruction 20, a plurality of terminals 200-1 to 200-3, and a control device 300.

The obstruction sensor 10 may be any sensor as long as it can detect an obstruction. The obstruction sensor 10 is, for example, a camera, a LiDAR or the like. The obstruction 20 may be a fixed object or a moving object. As the obstruction 20, for example, materials, machines, shelves, a person or the like in a factory is assumed.

Each of the terminals 200-1 to 200-3 is a terminal having a function of performing radio communication with the mobile base station 100. A part or all of the terminals 200-1 to 200-3 are specific priority terminals. The specific priority terminal is, for example, a monitoring camera terminal, and periodically performs communication at low frequency.

The control device 300 controls the mobile base station 100. The control device 300 may be disposed near the mobile base station 100 or at a remote location via a network. The control device 300 may be provided in the mobile base station 100. The mobile base station 100 and the control device 300 may be wired or wireless (IAB/WiGig or the like).

The mobile base station 100 is a base station capable of moving a movable portion 105 which is a portion including an antenna serving as a transmission/reception point of a radio signal. The direction of the antenna is also variable. The movable portion 105 may include an antenna, or may include a functional unit other than an antenna. The movable portion 105 may be an antenna itself.

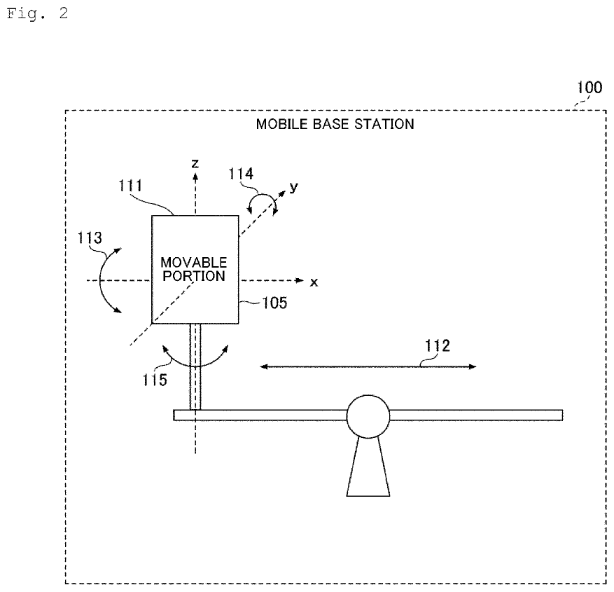

As illustrated in FIG. 2, for example, in the mobile base station 100, the position of the movable portion 105 can be changed in the direction indicated by reference numeral 112 by sliding the movable portion 105 on a rail. The rail can also be rotated in the horizontal direction. By this movement control, the movable portion 105 can be arranged at an arbitrary position within a predetermined range.

Also, for antenna direction control, for example, by a structure supporting the movable portion 105, the movable portion 105 is moved around the x-axis (refer to reference numeral 113), and it is possible to rotate and move around the y-axis (see reference numeral 114) and around the z-axis (see reference numeral 115). By this movement control, the antenna can be directed in an arbitrary direction.

It is to be noted that the use of the mobile base station 100 that slides on the rail as described above is merely an example. Any type of antenna may be used as long as the position and direction of the antenna provided in the base station can be changed. For example, a base station may be mounted on a drone or an automated guided vehicle (AGV) to control the position and direction of the antenna of the base station, or manually control the position and direction of the antenna of the base station.

Although the example illustrated in FIG. 1 illustrates an example in which only the mobile base station 100 exists as the base station, a base station having no movable function, the mobile base station may be used in combination. In this case, by fixing the position/direction parameters of the base station having no movable function and performing the processing described below, the position/direction parameters can be optimized in the same manner as in the case where only the mobile base station 100 is used.

### Detailed Configuration Example

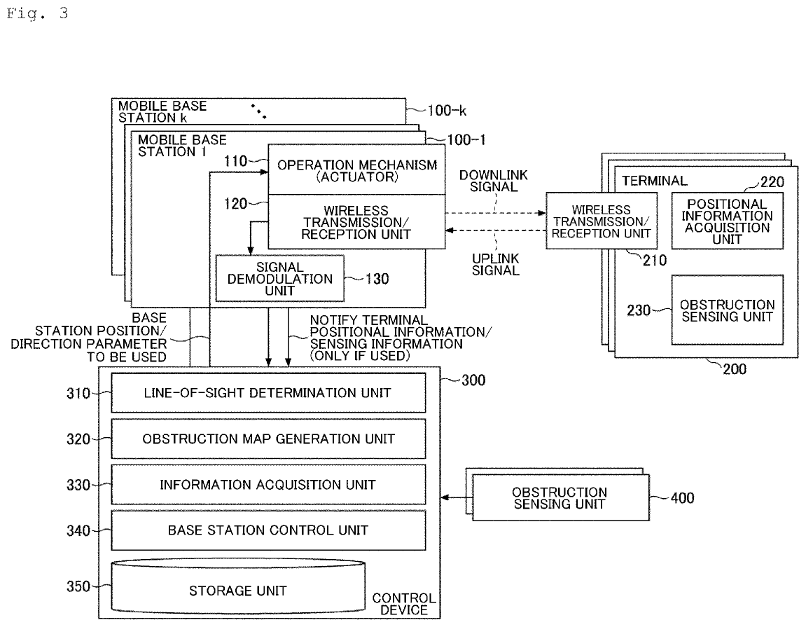

FIG. 3 illustrates the configuration of each device that configures the communication system according to the present embodiment. FIG. 3 illustrates an example of a case where k mobile base stations 100-1 to 100-k are provided. In a case where 1 to k are not particularly distinguished, they are described as “mobile base station 100”. It is also determined that a plurality of terminals 200 exist, and each terminal 200 is a specific priority terminal. An obstruction sensing unit 400 illustrated in FIG. 3 corresponds to the obstruction sensor 10 illustrated in FIG. 1. The obstruction sensing unit 400 may be a functional unit included in the control device 300.

### <Mobile Base Station 100>

As illustrated in FIG. 3, the mobile base station 100 includes an operation mechanism 110, a wireless transmission/reception unit 120, and a signal demodulation unit 130. The operation mechanism 110 is a mechanism for operating the movable portion 105. The operation mechanism 110 may be called an actuator. The movable portion 105 may be the wireless transmission/reception unit 120.

The wireless transmission/reception unit 120 has an antenna and transmits/receives wireless signals. The signal demodulation unit 130 receives the uplink signal from the wireless transmission/reception unit 120, demodulates the received signal, and transmits the demodulated signal to the control device 300.

### <Terminal 200>

The terminal 200 includes a wireless transmission/reception unit 210, a positional information acquisition unit 220, and an obstruction sensing 230. The wireless transmission/reception unit 210 transmits and receives a wireless signal. The positional information acquisition unit 220 acquires positional information of terminal 200 itself. The obstruction sensing unit 230 detects an obstruction. The obstruction sensing unit 230 may be a camera, a LiDAR, or other sensors.

In a case of using the positional information of the terminal 200 acquired by the terminal 200 in the control device 300, the positional information acquisition unit 220 transmits the positional information to the mobile base station 100 using an uplink data channel (or control channel), and the mobile base station 100 transmits the positional information to the control device 300.

The terminal 200 may not include the positional information acquisition unit 220. In this case, the control device 300 or the mobile base station 100 estimates the terminal position using a camera video or the like.

The obstruction sensing is performed by an obstruction sensing unit 400 provided separately from the terminal 200. However, in a case where the terminal 200 includes an obstruction sensing unit 230, the obstruction sensing unit 230 may notify the control device 300 of sensing information (camera video, RiDAR information, or the like) using an uplink signal. The terminal 200 may not include the obstruction sensing unit 230.

### <Control Device 300 (Control Apparatus)>

The control device 300 includes a line-of-sight determination unit 310, an obstruction map generation unit 320, an information acquisition unit 330, a base station control unit 340, and a storage unit 350. The outline of each part is as follows.

The information acquisition unit 330 acquires the obstruction sensing information, the positional information of the specific priority terminal 200, the communication interval of the specific priority terminal, and the like. The obstruction map generation unit 320 detects an obstruction based on the obstruction sensing information, generates a 3D (or 2D) map, and stores the information in the storage unit 350.

The line-of-sight determination unit 310 specifies a specific priority terminal which is in line-of-sight for each parameter of the position and direction of the antenna of the mobile base station 100 for each mobile base station, and stores the information in the storage unit 350. The base station control unit 340 performs movement control or the like for the mobile base station 100.

### (Operation Example of Communication System)

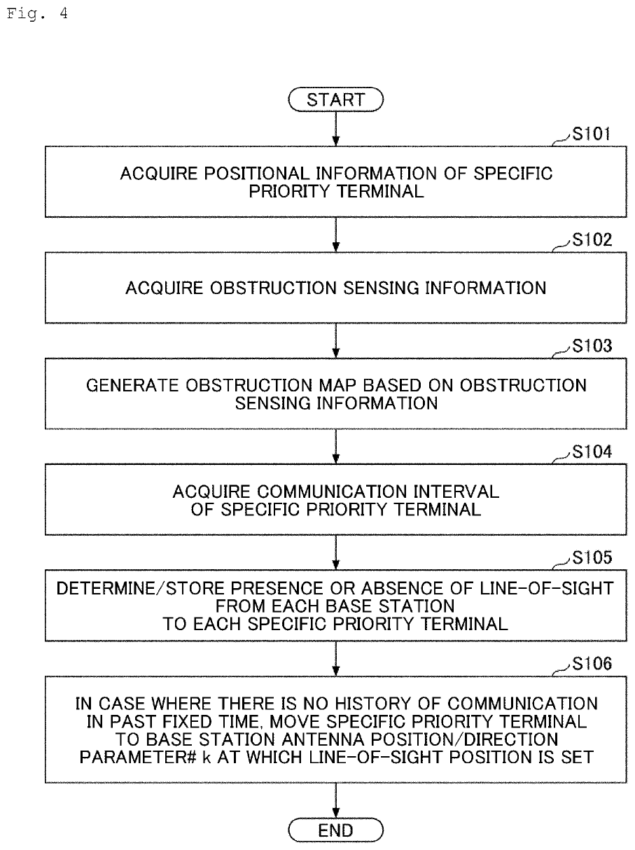

Next, an operation example of the communication system (specifically, the control device 300) will be described with reference to the flowchart illustrated in FIG. 4.

### <S101: Positional Information Acquisition>

First, in S101, the information acquisition unit 330 of the control device 300 acquires positional information of the specific priority terminal 200. In a case where there are a plurality of specific priority terminals 200, the positional information is acquired for each specific priority terminal 200.

The positional information may be obtained in any method. For example, positional information measured by the specific priority terminal 200 using three-point positioning, GPS or the like may be reported to the control device 300 through a data channel or a control channel. Alternatively, a scenario of the position of the specific priority terminal 200 may be prepared, and positional information (for example, the position at each time) according to the scenario may be stored in the storage unit 350 in advance.

### <S102: Obstruction Sensing Information Acquisition>

In S102, the information acquisition unit 330 acquires obstruction sensing information (camera video information, LiDAR information, or the like) obtained by the obstruction sensing unit 400, and stores the information in the storage unit 350.

### <S103: Obstruction Map Generation>

In S103, the obstruction map generation unit 320 detects an obstruction based on obstruction sensing information (camera video information, LiDAR information, or the like) acquired in S102 to generate a 3D map (or 2D map). The 3D map includes three-dimensional positional information of the obstruction. The 2D map includes two-dimensional positional information of the obstruction.

### <S104: Communication Interval Acquisition>

In step S104, the information acquisition unit 330 acquires the communication interval of each specific priority terminal 200. The communication interval may be obtained in any method. For example, if the communication interval is predetermined, the information may be input, the information may be predicted from the communication history by using machine learning, or the communication interval may be reported from the specific priority terminal 200.

### <S105: Line-of-Sight Determination>

In S105, the line-of-sight determination unit 310 determines presence/absence of a line-of-sight from the mobile base station 100 to each specific priority terminal 200, for each mobile base station 100, the positional information of the specific priority terminal 200 and the obstruction map, for each combination of parameters indicating the position and direction of the antenna of the mobile base station 100, and stores information on the determined presence/absence of the line-of-sight in the storage unit 350. A specific example of the line-of-sight determination method will be described later.

For example, it is assumed that two specific priority terminals 200-1 and 200-2 exist in one mobile base station 100, and parameters 1 to n indicating the position and direction of the antenna exist. A certain parameter m is, for example, {xₘ, yₘ, xₘ, pₘ, cₘ, and rₘ}. Here, xₘ, yₘ, and zₘ are each a x coordinate, a y coordinate, and a z coordinate of the antenna center position, and pₘ, cₘ, and rₘ are each the pan angle, the tilt angle, and roll angle of the antenna.

The line-of-sight determination unit 310 determines the presence or absence of the line-of-sight from the mobile base station 100 to the specific priority terminals 200-1 and 200-2 for each parameter, and stores, for example, the following information in the storage unit 350.

“Parameter 1: the presence of line-of-sight to the specific priority terminal 200-1 and the absence of line-of-sight to the specific priority terminal 200-2,” “Parameter 2: the presence of line-of-sight to the specific priority terminal 200-1 and the absence of line-of-sight to the specific priority terminal 200-2,” . . . , and “Parameter n: the absence of line-of-sight to the specific priority terminal 200-1 and the presence of line-of-sight to the specific priority terminal 200-2”.

In a case where there are a plurality of mobile base stations 100, the above-described information is stored in the storage unit 350 for each mobile base station 100.

### <S106: Antenna Position/Direction Control>

The information acquisition unit 330 always collects communication history for each specific priority terminal 200 and stores it in the storage unit 350.

The base station control unit 340 determines whether communication has been performed (whether there is a communication history) for each specific priority terminal 200 during a period from a time traced back to the past from the current time by the time length of the communication interval acquired in S104 to the current time. The period described above may not be equal to the time length of the communication interval, and may be a value based on the time length of the communication interval. For example, the above-mentioned period may be a period longer than or equal to the time length of the communication interval.

When it is detected that communication is not performed for a certain specific priority terminal 200 during the period, the base station control unit 340 transmits an antenna position/direction parameter #k by which the specific priority terminal 200 arrives at a line-of-sight position to the mobile base station 100, the position and direction of the antenna of the mobile base station 100 is moved in the position/direction indicated by the antenna position/direction parameter #K.

If there are a plurality of antenna position/direction parameters at which the specific priority terminal 200 is at a line-of-sight position, the base station control unit 340 estimates, for example, communication quality (for example, throughput) in the specific priority terminal 200 when it is assumed that each of the plurality of parameters is applied, and selects a parameter which makes communication quality best.

If there is an antenna position/direction parameter by which the specific priority terminal 200 arrives at a line-of-sight position for the plurality of mobile base stations 100, the base station control unit 340 performs the movement control for each mobile base station 100. This is because it is preferable from the viewpoint of communication quality and stability that the plurality of mobile base stations 100 are in a line-of-sight state.

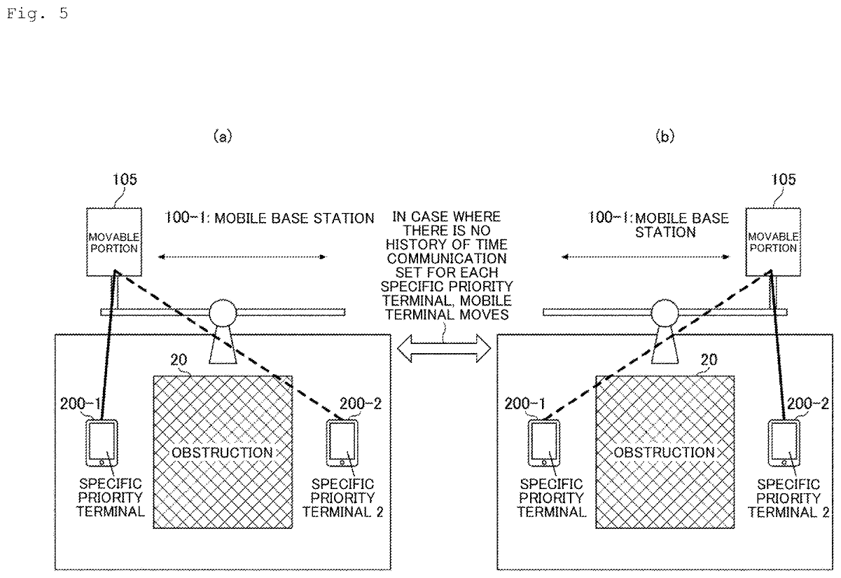

An example of the control will be described with reference to FIG. 5. First, it is assumed that the specific priority terminal 200-1 is in a line-of-sight state from the mobile base station 100-1 and the specific priority terminal 200-2 is not in a line-of-sight state from the mobile base station 100-1 at a certain point of time as illustrated in (a).

When the control device 300 detects that the state of (a) continues for a time length of a communication interval of the specific priority terminal 200-2 or longer, the control device 300 controls the position and direction of a movable portion (antenna) of the mobile base station 100-1 so that the specific priority terminal 200-2 is in a line-of-sight state from the mobile base station 100-1 as shown in (b).

By performing such control, highly reliable regular communication by the specific priority terminal 200 can be performed.

### (Example of Line-of-Sight Determination Method)

An example of a line-of-sight determination method executed by the line-of-sight determination unit 310 will be described below. Here, the following three examples will be described. The following three methods are examples, and the line-of-sight determination may be performed by a method other than the following three methods.

### <Line-of-Sight Determination Method 1>

In line-of-sight determination method 1, the line-of-sight determination unit 310 defines the line-of-sight area as an area through which a line segment extends from the point at the center position of the antenna until it collides with a wall or an obstruction. In this method, if the specific priority terminal 200 is included in the area, it can be determined that the specific priority terminal 200 is in a line-of-sight state.

According to the line-of-sight determination method 1, the line-of-sight area can be easily calculated only by the area shape, the obstruction position, and the obstruction shape regardless of the terminal position.

### <Line-of-Sight Determination Method 2>

In line-of-sight determination method 2, the line-of-sight determination unit 2 calculates the Fresnel zone for each point on a predetermined grid from the point of the antenna center position, and defines points where a predetermined x % of the Fresnel zone is not shielded as line-of-sight positions, and defines areas around these grids as line-of-sight areas. In this method, if the specific priority terminal 200 is included in the area, it can be determined that the specific priority terminal 200 is in the line-of-sight state.

According to the line-of-sight determination method 2, the line-of-sight area can be calculated only by the area shape, the obstruction position, and the obstruction shape regardless of the terminal position.

### <Line-of-Sight Determination Method 3>

In line-of-sight determination method 3, the line-of-sight determination unit 310 calculates the Fresnel zone for each terminal from the point of the antenna center position, and determines that a terminal in which predetermined x % of the Fresnel zone is not shielded is a terminal in the line-of-sight state.

According to the line-of-sight determination method 3, in a case where the terminal position is static to some extent, the line-of-sight position of the terminal actually communicating can be determined from the area shape, the obstruction position and the obstruction shape.

### <Regarding Calculation of Fresnel Zone>

The calculation of the Fresnel zone used in the above-mentioned line-of-sight determination methods 2 and 3 can be performed by the following equation.

$$d 3 = \sqrt{d {1}^{2} + r {1}^{2}} + \sqrt{d {2}^{2} + r {1}^{2}} - d = \frac{λ}{2} \qquad [ Math . 1 ]$$

$$r 1 ( m ) = \sqrt{λ \frac{d 1 d 2}{d 1 + d 2}} = \frac{\sqrt{λ d}}{2} \qquad [ Math . 2 ]$$

The meanings of the variables used in the above equations are as follows.

Shortest distance between sender and receiver: d (m) Radius of central part of spheroid (Fresnel radius): r1 (m) Distance between sender and center of spheroid: d1 (m) Distance between receiver and center of spheroid: d2 (m) Path difference between reflected wave and direct wave reflected at Fresnel radius: d3 (m)

### Wavelength: λ (m)

### Hardware Configuration Example

The control device 300 in the present embodiment can be realized by, for example, causing a computer to execute a program describing details of processing described in the present embodiment. Note that the “computer” may be a physical machine or a virtual machine in the cloud. When using a virtual machine, the “hardware” described here is virtual hardware.

The above program can be stored and distributed by being recorded in a computer-readable recording medium (portable memory or the like). Furthermore, the above program can also be provided through a network such as the Internet or an electronic mail.

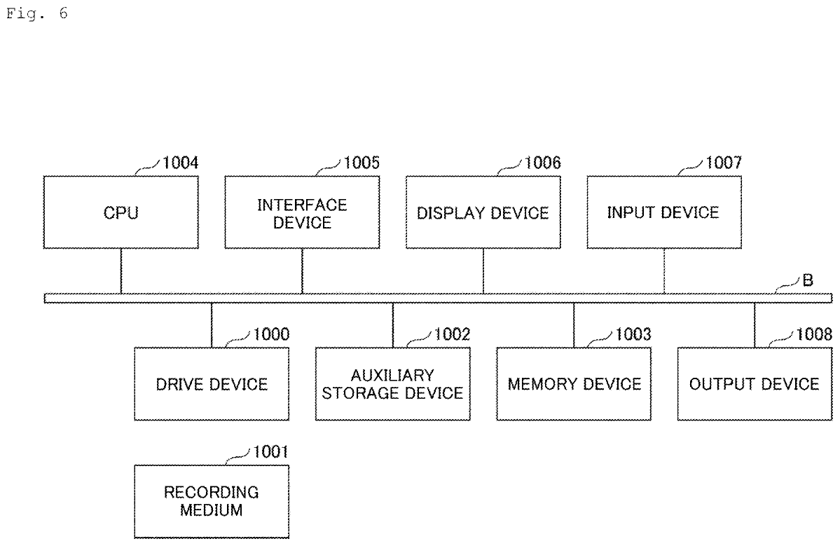

FIG. 6 is a diagram illustrating an example of a hardware configuration of the above computer. The computer illustrated in FIG. 6 has a drive device 1000, an auxiliary storage device 1002, a memory device 1003, a CPU 1004, an interface device 1005, a display device 1006, an input device 1007, an output device 1008, and the like, which are connected to each other by a bus B.

The program implementing processing in the computer is provided from a recording medium 1001 such as a CD-ROM or a memory card, for example. When the recording medium 1001 in which the program is stored is set in the drive device 1000, the program is installed from the recording medium 1001 to the auxiliary storage device 1002 through the drive device 1000. However, the program need not necessarily be installed from the recording medium 1001 and may be downloaded from another computer via a network. The auxiliary storage device 1002 stores the installed program and also stores necessary files, data, and the like.

The memory device 1003 reads and stores the program from the auxiliary storage device 1002 when there is an instruction to start the program. The CPU 1004 implements functions related to the control device 300 according to the program stored in the memory device 1003. The interface device 1005 is used as an interface for connection to a network. The display device 1006 displays a graphical user interface (GUI) or the like according to a program. The input device 1007 is constituted by a keyboard and a mouse, buttons, a touch panel, or the like and is used for inputting various operation instructions. The output device 1008 outputs a calculation result.

### Advantageous Effects of Embodiment

The technique according to the present embodiment controls parameters of the position and direction of the antenna of the mobile base station based on the communication interval related to the regular communication of the specific priority terminal, so that the periodic communication of the specific priority terminal can be maintained even in an environment where there is a moving obstruction, Communication reliability can be improved.

### Conclusion of Embodiment

This specification discloses at least a communication system, a control device (control apparatus), a control method, and a program according to the following items.

### (Clause 1)

A control apparatus in a communication system including the control apparatus and a mobile base station, the control apparatus including
an information acquisition unit that acquires positional information of a specific priority terminal and obstruction sensing information,
an obstruction map generation unit that generates an obstruction map based on the obstruction sensing information,
a line-of-sight determination unit that determines whether there is a line-of-sight from an antenna of the mobile base station for the specific priority terminal based on the positional information and the obstruction map, and
a base station control unit that controls the mobile base station so that the specific priority terminal is positioned at a line-of-sight position from the antenna in a case where communication by the specific priority terminal is not detected for a predetermined time.

### (Clause 2)

The control apparatus according to clause 1, in which the specific priority terminal is a terminal for periodically performing communication at a predetermined communication time interval, and the predetermined time is a time based on the communication time interval.

### (Clause 3)

The control apparatus according to clause 1 or 2, in which the line-of-sight determination unit determines whether there is a line-of-sight from the antenna for the specific priority terminal for each parameter indicating a position and a direction of the antenna of the mobile base station, and stores the determination result to a storage unit, and the base station control unit controls the mobile base station using a parameter by which the specific priority terminal arrives at a line-of-sight position from the antenna.

### (Clause 4)

A communication system including the control apparatus according to any one of clauses 1 to 3 and the mobile base station.

### (Clause 5)

A control method executed by a control apparatus in a communication system including the control apparatus and a mobile base station, the method including
an information acquisition step of acquiring positional information of a specific priority terminal and obstruction sensing information,
an obstruction map generation step of generating an obstruction map based on the obstruction sensing information, a line-of-sight determination step of determining whether there is a line-of-sight from an antenna of the mobile base station for the specific priority terminal based on the positional information and the obstruction map, and
a base station control step of controlling the mobile base station so that the specific priority terminal is positioned at a line-of-sight position from the antenna in a case where communication by the specific priority terminal is not detected for a predetermined time.

### (Clause 6)

A program for causing a computer to serve as each part in the control apparatus according to any one of clauses 1 to 3.

Although the embodiment has been described above, the present invention is not limited to the specific embodiment, and various modifications and changes can be made within the scope of the gist of the present invention described in the claims.

### REFERENCE SIGNS LIST

10 Obstruction sensor
20 Obstruction
100 Mobile base station
105 Movable portion
110 Operating mechanism
120 Wireless transmission/reception unit
130 Signal demodulation unit
200 Terminal
210 Wireless transmission/reception unit 2
220 Positional information acquisition unit
230 Obstruction sensing
300 Control device
310 Line-of-sight determination unit
320 Obstruction map generation unit
330 Information acquisition unit
340 Base station control unit
350 Storage unit
400 Obstruction sensing unit
1000 Drive device
1001 Recording medium
1002 Auxiliary storage device
1003 Memory device
1004 CPU
1005 Interface device
1006 Display device
1007 Input device
1008 Output device

1. A control apparatus in a communication system including the control apparatus and a mobile base station, the control apparatus comprising:
a processor; and
a memory that includes instructions, which when executed, cause the processor to execute a method, said method including:
acquiring positional information of a specific priority terminal and obstruction sensing information;
generating an obstruction map based on the obstruction sensing information;
determining whether there is a line-of-sight from an antenna of the mobile base station for the specific priority terminal based on the positional information and the obstruction map; and
controlling the mobile base station so that the specific priority terminal is positioned at a line-of-sight position from the antenna in a case where communication by the specific priority terminal is not detected for a predetermined time.

2. The control apparatus according to claim 1, wherein
the specific priority terminal is a terminal for periodically performing communication at a predetermined communication time interval, and
the predetermined time is a time based on the communication time interval.

3. The control apparatus according to claim 1, wherein
the determining includes determining whether there is a line-of-sight from the antenna for the specific priority terminal for each parameter indicating a position and a direction of the antenna of the mobile base station, and storing the determination result to a storage unit, and
the controlling includes controlling the mobile base station using a parameter by which the specific priority terminal arrives at a line-of-sight position from the antenna.

4. A communication system comprising:
the control apparatus according to claim 1; and
the mobile base station.

5. A control method executed by a computer in a control apparatus in a communication system including the control apparatus and a mobile base station, the method comprising:
acquiring positional information of a specific priority terminal and obstruction sensing information;
generating an obstruction map based on the obstruction sensing information;
determining whether there is a line-of-sight from an antenna of the mobile base station for the specific priority terminal based on the positional information and the obstruction map; and
controlling the mobile base station so that the specific priority terminal is positioned at a line-of-sight position from the antenna in a case where communication by the specific priority terminal is not detected for a predetermined time.

6. A non-transitory computer-readable recording medium having computer-readable instructions stored thereon, which when executed, cause a computer including a memory and a processor to execute the method according to claim 1.
